(19) United States
(12) Patent Application Publication
(10) Pub. No.: US 2002/0134079 A1
(43) Pub. Date: Sep. 26, 2002

(54) Hydraulic circuit for actuating multiple hydraulic receivers

(76) Inventors: Phillipe Fillon, Ternay (FR); Patrick Koetzel, La Verpilliere (FR)

Correspondence Address: MARTIN FLEIT, FLEIT KAIN GIBBONS GUTMAN & BONGINI, 520 BRICKELL KEY DRIVE #A201, MIAMI, FL, 33131, US

(21) Appl. No.: 09/817,798

(22) Filed: Mar. 26, 2001

(51) Int. Cl. F16D 31/02

(52) U.S. Cl. 60/422

(57) ABSTRACT

Hydraulic circuit for actuating multiple hydraulic receivers comprising: a multiple distribution device (1) with several valves (2₂-2₄) having functions for detecting the highest pressure load, anti-saturation and flow-splitting irrespective of the load (DDIC); a specific valve (2₁) for a specific receiver (12) being a major consumer of the flow from a hydraulic source (S), this receiver (12) also being of the DDIC type and connected in series with the other distributors; and a control circuit between the source (S) and the control port of the specific valve (2₁), having a pressure reducer (14) to lower the pressure of the fluid issuing from the source until a control value is reached, said pressure reducer (14) being adjustable so that the operation speed of said specific receiver can be pre-set.

### FIELD OF THE INVENTION

The present invention relates to improvements made to hydraulic circuits designed for operating multiple hydraulic receivers, these circuits comprising:

a source of pressurizedhydraulic fluid,

at least one multiple hydraulic distribution device comprising a plurality of valves assigned to actuating respective hydraulic receivers and which have a function for detecting the highest load pressure (pressure LS), an anti-saturation function and a flow split function irrespective of the load, and

at least one specific hydraulic valve assigned to actuating a specific hydraulic receiver which, during normal operation, may require at least the greater part of the maximum flow delivered by said hydraulic source,

said specific valve being also of the type having a function for detecting the highest load pressure, an anti-saturation function and a flow-splitting function independent of the load and being incorporated in said multiple hydraulic distributor device in series with the other valves, and

a hydraulic control circuit is connected between the hydraulic source and at least one control inlet of the specific valve operating said specific receiver, said circuit incorporating a pressure reducer designed to lower the high pressure of the hydraulic fluid leaving the source until a control value is reached, so that at least one other valve means can be operated so as to actuate another receiver whilst said specific receiver continues to function.

The term “specific” relating to the hydraulic valve does not mean that a valve with a special structure and/or function is provided (although this may well be the case), but is merely intended to denote one of several valves incorporated in the hydraulic circuit which is specifically assigned to activating said specific hydraulic receiver with a high flow consumption.

For the sake of simplification, the multiple hydraulic distribution device comprising a plurality of valves with a function for detecting the highest load pressure, an anti-saturation function and a flow split function irrespective of the load will be referred to as a “DDIC distributor device” throughout the following description.

### DESCRIPTION OF THE PRIOR ART

A typical example of a hydraulic receiver requiring a large hydraulic flow rate is a large hydraulic hammer supported on the end of a system comprising a boom and articulated arms moved by respective hydraulic actuators controlled by said DDIC distribution device. However, another receiver might be a small hand-held hydraulic hammer, for example, with a reversible hydraulic motor driving a cutter mounted on the end of a system of articulated arms (for use on banks at the side of the road), . . . .

In the circuits previously used, the specific valve designed to control the specific receiver was directly connected to the hydraulic source, in parallel on the DDIC distributor device. Under these conditions, when the specific receiver was operating and was taking in the entire or at least the greater part of the flow delivered by the hydraulic source, it was impossible to activate another hydraulic receiver controlled by the DDIC distributor device. For example, to be more specific, when the hydraulic hammer was operating, it was impossible to control one or more of the arms/boom within its support system to get this hammer to advance axially as and when the hole was being dug.

In the above recited arrangement, the mentioned problem has been overcame by the fact that the specific valve controlling the specific receiver was incorporated in the DDIC distributor device so that all the valves, including the specific valve, operated in split-flow mode irrespective of the load. This offered the possibility of being able to control, jointly with the specific receiver which may continue in operation, at least one other receiver—for example, axial displacement of a hydraulic hammer during operation-.

However, despite obtained results, the above mentioned circuit is not considered as being entirely satisfactory because the user must simultaneously control a too high number of hydraulic parameters and, on another hand, it is important that said specific receiver will continue to operate with its entire efficiency (the other receivers simultaneously controlled according to specified features having a possibility to pursue operation with a reduced speed).

### SUMMARY OF THE INVENTION

The objective of the invention is consequently to remedy the commonly found drawbacks outlined above as far as possible and to propose an improved design for a hydraulic circuit which enables said specific receiver to be conveniently controlled whilst continuing operation.

To this end, the invention proposes a hydraulic circuit for operating multiple hydraulic loads as outlined above which is characterised in that said pressure reducer of the hydraulic control circuit of said specific valve is adjustable, whereby it is possible to pre-set the operating speed of said specific receiver and consequently to maintain it in operation in predetermined conditions.

In order to ensure that the circuit operates in safety, it is desirable for the hydraulic control circuit of the specific valve additionally to include a pressure limiter, calibrated to a predetermined value corresponding to the maximum permissible pressure for controlling said specific valve.

By preference, so that the specific receiver can be operated independently of the other receiver, the hydraulic control circuit of the specific valve may additionally be provided with at least one Go/Stop control solenoid.

If the specific receiver is capable of operating in two possible directions (for example a reversible hydraulic motor, double-acting actuator), the hydraulic control circuit of the specific valve will have two Stop/Go control solenoids corresponding respectively to the two possible operating directions.

All in all, the features proposed by the invention constitute a very attractive solution to the problems inherent in the known designs.

### BRIEF DESCRIPTION OF THE DRAWINGS

The invention will be more readily understood from the detailed description of preferred embodiments below, given solely by way of illustration and not restrictive in any respect. Throughout the description, reference will be made to the appended drawings, of which:

FIG. 1 is a diagram of the hydraulic circuit proposed by the invention, adapted for a specific receiver operating in one direction only; and

FIG. 2 is a diagram of the hydraulic circuit proposed by the invention for a specific receiver with two possible operating directions.

### DETAILED DESCRIPTION OF THE INVENTION

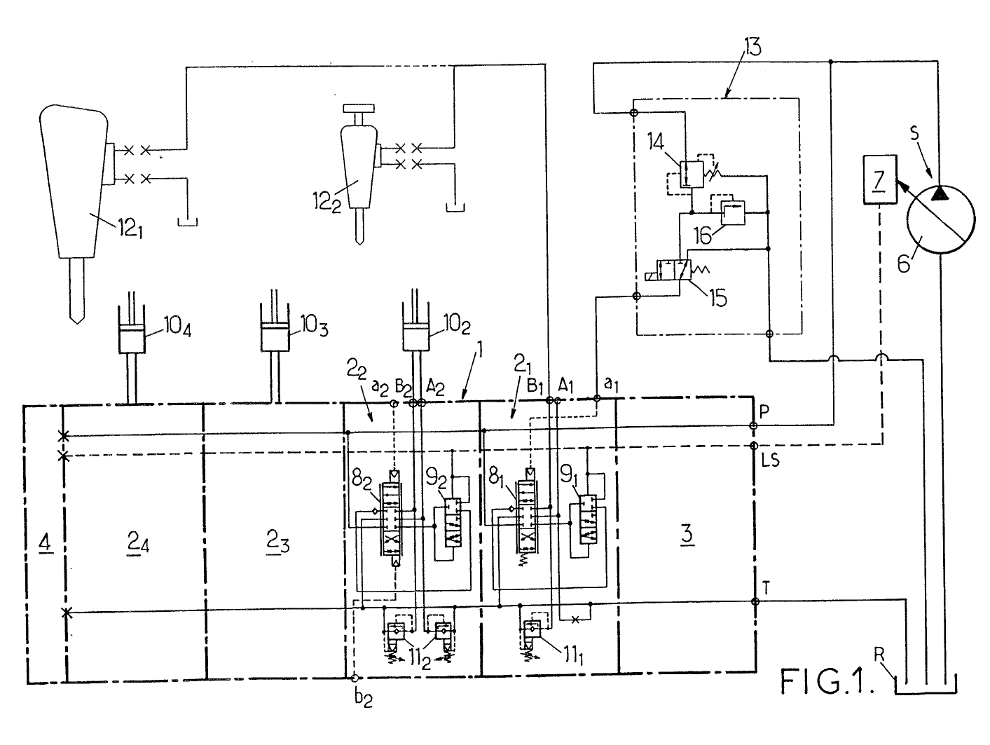

Turning firstly to FIG. 1, a hydraulic circuit has a hydraulic distributor device 1 comprising a plurality of valves 2 assigned to the control of respective hydraulic receivers which have a function for detecting the highest load pressure (pressure LS) of all the receivers, an anti-saturation function and a flow-dividing function irrespective of the load (DDIC distributor means).

In a conventional manner, the distribution device 1 comprises an inlet block 3, several distribution blocks 2 (in this case four blocks 2₁ to 2₄ are illustrated by way of example), and finally a end block 4. In a manner known per se, the distribution device 1 may be of a design in which the blocks listed above are arranged in a sealed stack, face to face. Each inlet and distribution block has three passages face to face passing therethrough, namely a passage P supplying compressed fluid, a passage T for returning the working fluid to a reservoir and a fluid control passage at the highest pressure load (pressure LS). Because the blocks are stacked one against the other, the various passages are disposed in succession one after the other and constitute three continuous fluid circulation lines passing end to end through the distribution device 1 (line P, line T and line LS, respectively).

The end block 4 sealingly closes off the terminal ends of said three lines.

The inlet block 3 has an inlet orifice, enabling the line p to communicate with a source S of pressurized fluid. In the example illustrated here, the source S is a variable flow pump 6 fitted with a power regulator 7 driven by the pressure LS delivered by the line LS of the distribution device 1; however, other types of hydraulic source may also be used without departing from the scope of the invention. Finally, the inlet block 3 has an outlet port connecting the line T to a reservoir R.

The inlet block 3 may be provided will all the elements (not illustrated) conventionally provided here to enable the distribution device 1 to operate effectively and efficiently, these being known to the person skilled in the art.

Each distribution block 2₂ to 2₄ may be substantially identical to the others. Taking block 2₂ as an example, the structure of which has already been described in detail (the other blocks 2₃ and 2₄ are illustrated in the form of empty rectangles so as to avoid overloading the drawing), a valve of the DDIC type 8₂ is provided, having three passages and three positions (illustrated in a neutral position), which is connected on the one hand to said lines P, T and LS and on the other to two working ports A₂, B₂ to which a hydraulic receiver 10₂ to be controlled by said valve 8₂ is connected. Displacement of the slide of the valve 8₂ may be hydraulically controlled, in which case, as illustrated in FIG. 1, the two hydraulic controls associated with the opposing ends of the slide are connected respectively to two respective control ports a₂, b₂ to which an appropriate control member is connected, for example a manipulator or similar (not illustrated).

A balance 9₂ with two passages and three positions receives the working fluid pressure (via the third passage of the valve 8₂) and the pressure LS, so that the pressure differential between the pressure LS at one side and the working pressure of the receiver 10₂, at the other side acts on this balance which establishes a link between the line LS if the working pressure of the receiver 10₂ rises above the pressure LS.

Two pressure limiters 11₂ are disposed respectively in the starting lines A₂, B₂.

The hydraulic receivers 10₂, 10₃ and 10₄ may be hydraulic actuators, for example, operating the arms and boom of a work tool and any number of them may be provided.

The purpose of the specific distributor block 2₁ is to control a specific hydraulic receiver 12. It is assumed, in the context of the invention, that this receiver 12 alone takes up all or at least the greater part of the flow supplied by the hydraulic source S. Such a receiver might be a hydraulic hammer 12₁, for example, mounted on the end of the arms/boom system of the tool, or even a hand-held hydraulic hammer 12₂. A receiver 12 of this type operates in single-acting mode (spring return) and is therefore connected between only one of the working ports (B₁ for example) of the block 2₁ and the reservoir. Accordingly, the other working port A₁ is suppressed. The distributor block 2₁ may be identical to the block 2₂ described above or alternatively (as illustrated) may be adapted to its specific control function, having only a single pressure limiter 11₁ associated with the working port B₁ and a single control slide of the valve 8₁ connected to the control port a₁.

Connected to the control port a₁ is a control circuit 13 incorporating a pressure reducer 14 of the adjustable type as illustrated in FIG. 1 so that the operating speed of the receiver 12 can be pre-set. The inlet of this pressure reducer 14 receives the pump pressure P and the outlet is returned to a reduced pressure (for example between 0 and 50 bar, compared with 0 to 250 bar for the pressure P) which is applied to the control inlet a₁ of the distributor block 2₁.

So that the hydraulic receiver 12 can be operated or halted independently of the other receivers 10₂ to 10₄, a solenoid 15 is inserted, downstream of the pressure reducer 14, having one passage and two positions, GO and STOP respectively. This solenoid may be controlled by an electric switch (not illustrated) operable by the user.

In order to ensure safe operation in terms of hydraulic overload, a pressure limiter 16 may be provided at the outlet of the pressure reducer 13, calibrated to the maximum permissible pressure value of the distributor control system 8₁.

Accordingly, the specific distributor block 2₁ designed to control the specific receiver 12 is connected in series in the multiple DDIC distributor device 1 and is operated on the flow split system irrespective of the load, which enables this specific receiver 12 to be kept in operation when one of the other receivers 10₂ to 10₄ is simultaneously switched to operating mode. Moreover, because it has its own control circuit 13, said specific receiver 12 remains in an appropriate control mode.

A design of this type resolves the operating difficulties encountered when using this type of hydraulic receiver in the past. In particular, this being a large hydraulic hammer 12₁, it is now possible, without halting operation of the hammer 12₁, to displace it axially and in sequence by acting on the actuators 10₂ to 10₄ operating the arms/support; the hammer may then be held permanently and appropriately supported on the obstacle, which will improve the quality of its work.

The slowing which may occur during simultaneous operation of the specific receiver and the other receiver due to the inadequate flow supplied by the source S is not inherently detrimental because the other receiver is activated sequentially only and for brief periods of time.

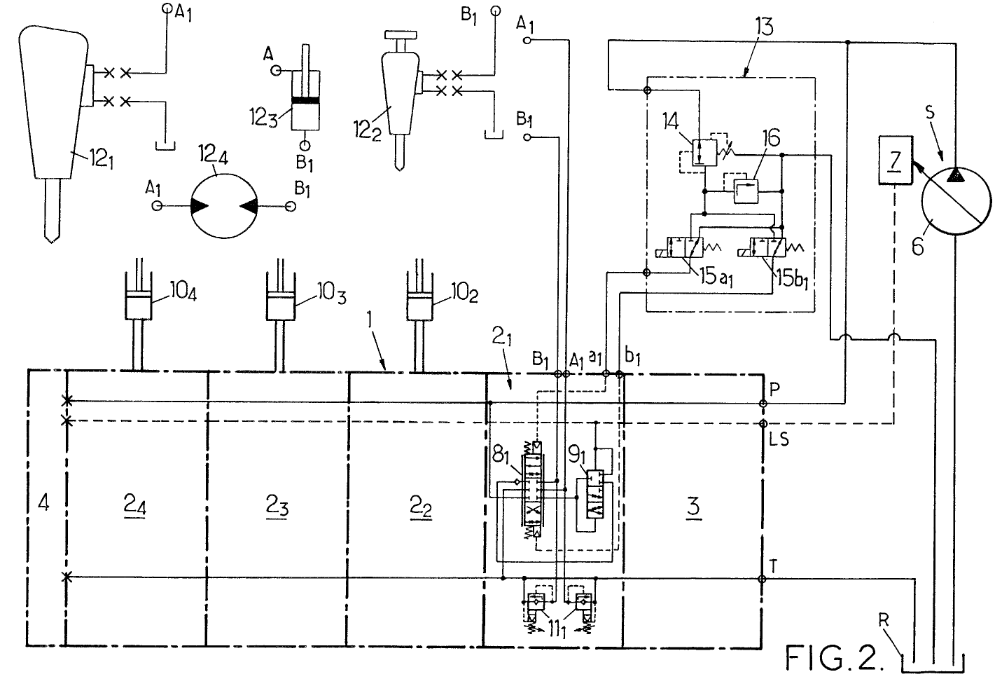

FIG. 2 is a hydraulic diagram similar to that illustrated in FIG. 1 but adapted to control a specific hydraulic receiver which operates in two directions. Accordingly, this circuit offers the possibility of operating a single-acting tool (large hydraulic hammer 12₁ or a small, hand-held hydraulic hammer 12₂) as well as a double-acting actuator 12₃ or a reversible hydraulic motor 12₄.

To this end, the specific distributor block 2₁ in this instance is of the same design as the distributor block 2₂ described above. Its two outlet orifices A₁ and B₁ are functional and two respective pressure limiters 11₁ are operated. The valve 8₁ is provided with two hydraulic controls respectively for each direction of slide displacement, which are connected respectively to the control ports a₁ and b₁.

The control circuit 13 has the same layout as that of FIG. 1, the only difference being that the single solenoid is replaced by two solenoids 15ₐ₁, and 15_{b1} mounted so that they can be activated in opposition in order to control a₁ or b₁ selectively.

What is claimed is:

1. A hydraulic circuit for actuating multiple hydraulic receivers, comprising:
a source of pressurized hydraulic fluid,
at least one multiple hydraulic distribution device comprising a plurality of valves assigned to activating respective receivers and which have a function for detecting the highest load pressure (pressure LS), an anti-saturation function and a function for dividing the flow irrespective of the load,
at least one specific hydraulic valve assigned to activating a specific hydraulic receiver which, during normal operation, may require at least the greater part of the maximum flow delivered by the hydraulic source, said specific distributor means also being of the type having a function for detecting the highest pressure load, an anti-saturation function and a function for dividing the flow irrespective of the load and being incorporated in said multiple hydraulic distribution device in series with the other valves, and
between the hydraulic source and at least one control inlet of the specific valve actuating said specific receiver, a hydraulic control circuit incorporating a pressure reducer designed to lower the high pressure of the hydraulic fluid issuing from the source until a control value is reached so that pressure may be applied to at least one other valve in order to activate another receiver whilst said specific receiver continues to function,
wherein the pressure reducer of the hydraulic control circuit of the specific valve is adjustable, whereby the operating speed of said specific receiver can be pre-set.

2. A hydraulic circuit according to claim 1, wherein the hydraulic control circuit of the specific valve additionally comprises a pressure limiter calibrated for a predetermined value corresponding to the maximum permissible pressure for the control of said specific valve.

3. A hydraulic circuit according to claim 1, wherein the hydraulic control circuit of the specific valve additionally comprises at least one Go/Stop control solenoid.

4. A hydraulic circuit according to claim 1, in which the specific receiver has two possible operating directions, wherein the hydraulic control circuit of the specific valve has two Go/Stop control solenoids corresponding respectively to the two possible operating directions.

5. A hydraulic circuit according to claim 1, wherein the specific receiver is a hydraulic hammer/hammer drill.

6. A hydraulic circuit according to claim 4, wherein the specific receiver is a double-acting actuator or a hydraulic motor with two directions of rotation.
